(19) United States
(12) Patent Application Publication
(10) Pub. No.: US 2008/0294077 A1
(43) Pub. Date: Nov. 27, 2008

(54) Treatment Device for the Human Body

(76) Inventor: Stephen Terry Walker, West Sussex (GB)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 11/922,649

(22) PCT Filed: Jun. 19, 2006
(86) PCT No.: PCT/GB2006/002228

§ 371 Date: Jul. 24, 2008

(30) Foreign Application Priority Data
Jun. 20, 2005 (GB) 0512593.5

(51) Int. Cl. A61H 7/00

(52) U.S. Cl. 601/135; 601/134

(57) ABSTRACT

A treatment device for the human body comprising a massaging member with a first end and a second end, each provided with attachment means adapted to attach to any part of a user's lower limbs, in which the massaging member is adapted and dimensioned to fit around any part of a user's torso, neck or head when the attachment means are attached to any part of the user's lower limbs.

This invention relates to a treatment device for the human body, which can massage and/or exercise the body and which has multiple applications.

Massage can be a very beneficial treatment which can alleviate aches and strains, and can stimulate blood flow and well-being. However, it is not really possible for a person to effectively massage certain parts of their own body, in particular their back and neck. Thus, it is necessary to have a masseuse perform such massages, which can be quite expensive and inconvenient.

It is also important to take exercise. In particular, it is important not to sit in a cramped position for extended periods of time without exercising. This has been proved in recent years with the realisation that deep vein thrombosis was responsible for several deaths on long-haul air flights after passengers sat in a cramped seat for many hours at a time. It is now recognised that anyone who sits still for long periods may be at risk, and this includes anyone from office workers and the elderly or infirm.

When convalescing after an injury or operation, some patients are bedridden for extended periods. As a result, their bodies can weaken and muscles can decay. A similar effect is experienced in space. Astronauts struggle to maintain body fitness when stationed in space for prolonged periods. The lack of gravity results in many muscles receiving no exercise at all. Various elaborate devices are used to maintain fitness, for example running machines to which the astronaut is strapped with resilient bungee cords to simulate gravity.

The object of the present invention is to overcome some of the above problems.

Therefore, according to the present invention a treatment device for the human body comprises a massaging member with a first end and a second end, each provided with attachment means adapted to attach to any part of a user's lower limbs, in which the massaging member is adapted and dimensioned to fit around any part of a user's torso, neck or head when the attachment means are attached to any part of the user's lower limbs.

Preferably the first end and said second end can be provided with cord means, ends of which can carry said attachment means. In a preferred construction the attachment means can be for attachment to a user's feet, and therefore they can comprise foot stirrups.

The massaging member can comprise a flexible strap means carrying one or more massaging bodies. In a preferred construction the flexible strap means can comprise a sleeve of material, inside which are carried the one or more massaging bodies. The massaging bodies can comprise one or more resilient balls, which can have a diameter less than the width of said sleeve, such that they can rotate in relation to said sleeve in use.

The ends of the sleeve can be provided with pockets adapted to receive said cord means and said foot stirrups in a storage arrangement. The cord means can be adjustable in length, and the resilient balls can be constructed from polyethylene foam.

The cords can be adjusted in length by means of a cord length adjustment catch comprising a hollow cylinder with a first end and a second end and an opening formed along one side, in which a first end of the opening tapers to a point towards the first end of the cylinder, in which in use a cord to be length adjusted is threaded through the first end of the cylinder and out of the opening, and is releasably fastened by jamming it into the tapered first end of the opening. This catch is the subject of the applicant's co-pending UK Patent Application and further explanation can be found therein.

The invention can be performed in various ways, but one embodiment will now be described by way of example and with reference to the accompanying drawing in which

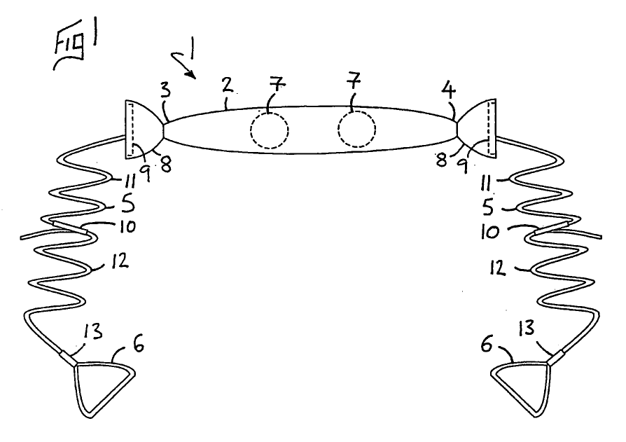

FIG. 1 is a front view of a treatment device according to the present invention.

As shown in FIG. 1, a treatment device for the human body 1 comprises a massaging member, in the form of sleeve 2, which has a first end 3 and a second end 4. Each end 3, 4, is provided with attachment means adapted to attach to any part of a user's lower limbs, in the form of cords 5 and foot stirrups 6. As described below the massaging member (2) is adapted and dimensioned to fit around any part of a user's torso, neck or head (not shown), when the attachment means (5, 6) are attached to any part of the user's lower limbs, which in this case are their feet (not shown).

The massaging member comprises the sleeve 2, which carries two resilient massaging balls 7 made from polyethylene foam (the outlines of which are shown). As is clear from FIG. 1, the balls 7 have a diameter less than the width of the sleeve 2, such that they can rotate in relation to the sleeve 2 in use.

The ends 3, 4 of the sleeve 2 are provided with pockets 8 adapted to carry the cords 5 and foot stirrups 6 in a storage arrangement as described below. The pockets are provided with hook and loop fasteners 9 at their openings to close them in use (the outlines of which are shown).

The cords 5 are adjustable in length by means of length adjustment catches 10. The cords comprise a first part 11 the inner end of which is attached to the inside of the pockets 8, and the outer end of which is attached to catches 10, and a second part 12, the inner end of which is adjustably carried by the catches 10, and the outer end of which carries the foot stirrups 6.

The foot stirrups 6 can also be adjusted in use by means of sliding adjuster 13.

The sleeve 2 and the pockets 8 are constructed from one large sleeve. To form the pockets 8, the ends of the large sleeve are folded back, and the inner ends of the cords 5 are tied around the outermost part of the folded back section, thereby to close the sleeve at both ends. The material which has been folded back is then folded in the opposite direction back over the tied part, thereby to form the pockets 8. Such a construction is readily produced, and can be easily dismantled to add or remove the balls 7.

To use the device 1, the pockets 8 are opened, and the cords 5 and foot stirrups removed therefrom, as shown in FIG. 1. The device can then be used to massage the user and provide exercise for their feet in a number of different ways.

In one method the sleeve 2 is placed around the user's neck. The balls 7 can be manipulated in the sleeve to position then as desired, so they act against particular parts of the neck. The user places their feet in the stirrups 6, and slides the adjuster 13 down to secure the stirrups 6 thereon. The user then seats themselves in a comfortable position with their heels on the ground. The cords 5 are adjusted using the catches 10, so the cords 5 are taught when the user's feet are in a mid position between extended forward and lifted up. Once ready, the user pushes their feet up and down alternately in the manner of walking, and as a result the sleeve 2 moves back and forth around their neck. The resilient balls 7 roll over the user because they can rotate inside the sleeve 2 due to their smaller size.

This action has three benefits. Firstly, the balls 7 rotate back and forth against the user's neck, providing a massaging effect. The massaging effect can be powerful and effective because it is driven by the user's legs. If the sleeve 2 were pulled back and forth by the hands, the massaging effect would be reduced, and it would be difficult to maintain the action for long. However, the legs are much stronger, and can work for much longer.

Secondly, the user must exercise their feet, in particular using the muscles of the lower leg, which not only provides valuable exercise, but can also prevent the occurrence of deep vain thrombosis, for example on long haul air flights. The action of the lower legs when operating the device mimics the act of walking, so the user can benefit from the effects of a short walk without getting up.

Thirdly, the user must hold their body steady in the seated position in order to keep the cords 5 taught between their neck and feet. This requires physical effort and exercises and stretches in particular the lower back.

In an alternative arrangement to that described above, the user can wrap the sleeve 7 under one shoulder, such that it extends from the neck down over the upper back. The same foot movement is carried out, and the massaging effect is provided to the upper back as opposed to the neck. This can be done on both sides.

It will be appreciated that the device can be used in any way which involves the sleeve 2 being wrapped around some part of the user's torso, neck or head and there are multiple ways this can be done, although the most effective are as described above.

In order to provide a slightly different massaging effect the foot stirrups 6 can be switched over to the opposite feet. This pulls the sleeve 2 further around the user's torso, neck or head, and provides a different massaging effect.

It is also possible to use the device when lying down, as opposed to sitting. The user's feet are placed in the stirrups, and the sleeve 2 is placed around any part of their torso, neck or head, including over one shoulder. This arrangement is suitable for the bedridden.

When the device 1 is no longer required, the cords 5 and foot stirrups 6 can be folded up and placed in the pockets 8. The hook and loop fasteners can be used to close the pockets 8.

The above described embodiment can be altered without departing from the scope of Claim 1. For example, in alternative embodiments (not shown) other massaging members are used in place of the balls in the sleeve. These can be ribbed or otherwise shaped flexible strap-like members made from any material, which wrap around the user and provide a massaging effect in use as described above. Of course, versions can also be created in which one or three or mall balls are used in a sleeve as opposed to two.

In other alternative embodiments (not shown), the foot stirrups are replaced with means to attach to other parts of the leg, and in particular around the thigh. The thigh can be moved up and down to create the required movement of the massage member, and such a version can exercise and relieve stress in the muscles of the upper leg.

Thus a treatment device is provided which provides a powerful self-applied massage to upper parts of the body, and at the same time provides an exercise for the lower limbs. The device also exercises the lower back, and can be used in a stationary seated or lying position, and even in zero gravity.

1. A treatment device for the human body comprising a massaging member with a first end and a second end, each provided with attachment means adapted to attach to any part of a user's lower limbs, in which the massaging member is adapted and dimensioned to fit around any part of a user's torso, neck or head when the attachment means are attached to any part of the user's lower limbs.

2. A treatment device as claimed in claim 1 in which said first end and said second end are provided with cord means, ends of which carry said attachment means.

3. A treatment device as claimed in claim 2 in which the attachment means comprise foot stirrups.

4. A treatment device as claimed in claim 3 in which the massaging member comprises a flexible strap means carrying one or more massaging bodies.

5. A treatment device as claimed in claim 4 in which the flexible strap means comprises a sleeve of material, inside which are carried the one or more massaging bodies.

6. A treatment device as claimed in claim 5 in which said one or more massaging bodies comprise one or more resilient balls, which one or more resilient balls have a diameter less than the width of said sleeve, such that they can rotate in relation to said sleeve in use.

7. A treatment device as claimed in claim 6 in which two resilient balls are provided.

8. A treatment device as claimed in claim 7 in which the first end and the second end of the massaging member are provided with pockets adapted to receive said cord means and said foot stirrups in a storage arrangement.

9. A treatment device as claimed in claim 8 in which the cord means are adjustable in length.

10. A treatment device as claimed in claim 9 in which the resilient balls are constructed from polyethylene foam.

11. A treatment device substantially as described herein and as shown in FIG. 1.
